(19) United States
(12) Patent Application Publication
(10) Pub. No.: US 2017/0012835 A1
(43) Pub. Date: Jan. 12, 2017

(54) Generating Traffic Query Responses Using an Interface Map

(71) Applicant: Cisco Technology, Inc., San Jose, CA (US)

(72) Inventor: Claudio Alberto Ortega, Redwood City, CA (US)

(21) Appl. No.: 14/791,552

(22) Filed: Jul. 6, 2015

(51) Int. Cl. H04L 12/26

(52) U.S. Cl. CPC H04L 43/04; H04L 43/10

(57) ABSTRACT

In one embodiment, a method includes: obtaining a query for network traffic associated with an interface of a node in a network. The method includes obtaining a plurality of traffic counters associated with the interface based on an interface map, where each of the traffic counters characterizes an amount of traffic traversing the interface for a particular monitoring period. The method includes determining a traffic result for the interface based on the plurality of traffic counters, where the traffic result is a function of the network traffic handled by the interface over a predetermined time period. In some implementations, the interface map includes an entry for each interface in the network, and each entry is characterized by a pointer to a list including a plurality of traffic counters for a corresponding interface and a characterization vector associated with the corresponding interface.

### TECHNICAL FIELD

The present disclosure generally relates to network traffic management, and in particular, to systems, methods, and devices enabling responses to traffic queries.

### BACKGROUND

Network management applications typically uses traffic measurements in order to conceptualize how network traffic traverses the network. This enables the network operator to, for example, scale up the infrastructure of more frequently used nodes (e.g., adding line cards) or shift traffic away from congested nodes to under-utilized ones.

As one example, a suite of analysis tools is run on the network every 15 minutes to produce an analysis file with information corresponding to the utilization and state of the network. One of the tools produces a traffic estimation for each interface in the network. This tool obtains two traffic measurement samples for each interface during the 15 minute period and averages those two traffic measurement samples to produce a traffic estimation for each interface.

Continuing with this example, after the analysis file is produced, a network controller receives a request for the traffic associated with a particular interface. In response to the request, the network controller identifies the traffic estimation associated with the particular interface from the analysis file and provides it to the requestor. However, the traffic estimation only provides a data point related to the previous 15 minute period without regard to any previous data points. Moreover, the traffic estimation could be as old as 15 minutes in this scenario. This leads to inaccurate results, which are not up to date and do not incorporate any past results.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example topology of a data network environment in accordance with some implementations.

FIG. 2 is a block diagram of a data processing environment in accordance with some implementations.

FIG. 3 is a block diagram of example data structures in accordance with some implementations.

FIG. 4 is a flowchart representation of a method of responding to traffic queries in accordance with some implementations.

FIG. 5 is a flowchart representation of a method of generating and maintaining an interface map in accordance with some implementations.

FIG. 6 is a block diagram of an example of a network device in accordance with some implementations.

FIG. 7 is a block diagram of an example of a network controller in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION OF EXAMPLE EMBODIMENTS

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

### Overview

Various implementations disclosed herein include devices, systems, and methods for utilizing and maintaining an interface map for a network in order to respond to traffic queries. For example, in some implementations, a method includes obtaining a query for network traffic associated with an interface of a node in a network. The method also includes obtaining a plurality of traffic counters associated with the interface based on an interface map, where each of the traffic counters characterizes an amount of traffic traversing the interface for a particular monitoring period. The method further includes determining a traffic result for the interface based on the plurality of traffic counters, where the traffic result is a function of the network traffic handled by the interface over a predetermined time period.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### Example Embodiments

Previously available network traffic analysis systems run a suite of analysis tools on a monitored network every, for example, 15 minutes. One of the suite of tools produces a traffic estimation for each interface in the network. This tool obtains two traffic measurement samples for each interface during the 15 minute period and averages those two traffic measurement samples to produce a traffic estimation for each interface. This produces an instantaneous traffic result that quickly becomes out of date and also provides no further reference to previous traffic measurements.

Various implementations disclosed herein obtain traffic counters from each interface in the network on a continuous basis according to a predetermined monitoring period (e.g., a sampling frequency such as 30 seconds, 60 seconds, 90 seconds, 5 minutes, 15 minutes, or the like). According to some implementations, a predetermined number of batches of traffic counters (e.g., a specified monitoring window associated with 6 monitoring periods) are kept in memory in order to respond to traffic queries with greater accuracy due to a lesser period of time between the time of the latest traffic counters and the time of the request.

In some circumstances, a typical network includes on the order of 10⁵ to 10⁶ interfaces. As such, when responding to a query for traffic associated with a specified interface, the network traffic analysis system should be efficient when identifying traffic counters associated with the specified interface to provide a response to the query. Otherwise, the processing time grows as the number of batches stored in the database increases and also as the number of interfaces in the network increases (and consequently the number of traffic counters per batch). Various implementations disclosed herein mitigate the aforementioned traffic counter processing bottleneck by providing scalable processing of traffic counters with the use of an associate array type of data structure in the form of an interface map. For example, in some implementations, the interface map includes an entry for each interface in the network and each entry associates or correlates a particular interface with a lists of traffic counters that were obtained within a specified monitoring window, all of which are associated with that particular interface.

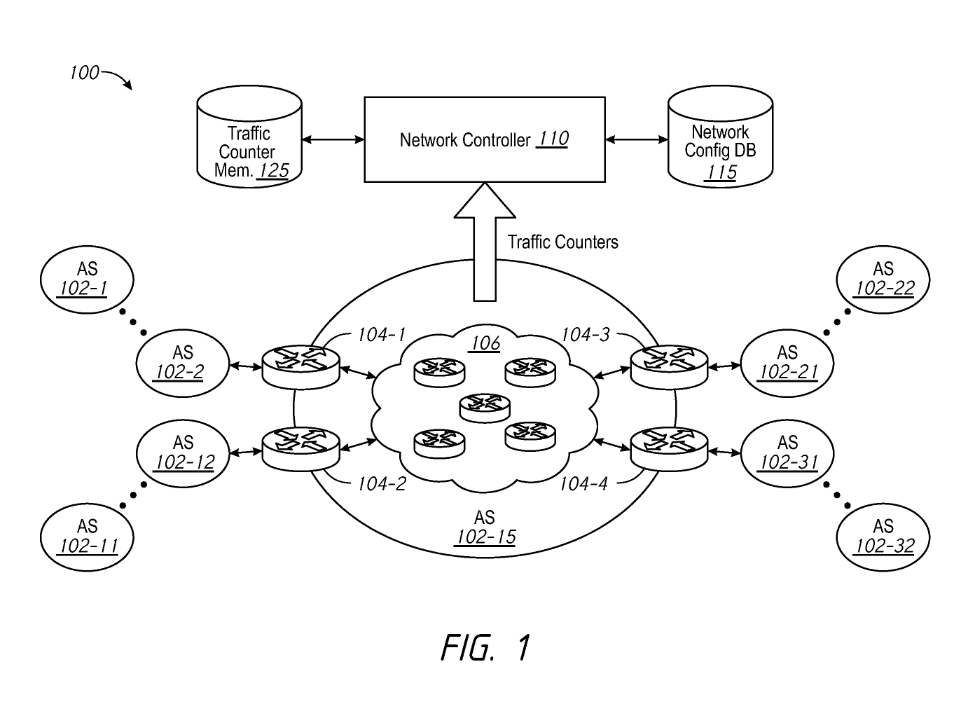

FIG. 1 is a block diagram of an example topology of a data network environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the data network environment 100 includes a plurality of autonomous systems 102, a network controller 110, a network configuration database 115, and a traffic counter memory 125. In accordance with some implementations, an autonomous system (AS) refers to a group of routers within a network that are subject to common administration and a same interior gateway protocol (IGP) such as the routing information protocol (RIP), the interior gateway routing protocol (IGRP), the enhanced interior gateway routing protocol (EIGRP), the open shorted path first (OSPF) protocol, intermediate system to intermediate system (IS-IS) protocol, or the like. In some implementations, those of ordinary skill in the art will appreciate from the present disclosure that the data network environment 100 includes an arbitrary number of AS's.

As shown in FIG. 1, an AS 102-15 (sometimes also herein referred to as the “customer network” or the “monitored network”) includes a plurality of border routers 104-1, 104-2, 104-3, and 104-4 configured to connect the AS 102-15 with other AS's. For example, the border routers 104 communicate with AS's that are external to the AS 102-15 via an exterior gateway protocol (EGP) such as the border gateway protocol (BGP). The border routers 104 are also connected to a plurality of intra-AS routers 106 within the AS 102-15. Intra-AS routers 106 broadly represent any element of network infrastructure that is configured to switch or forward data packets according to a routing protocol or switching protocol. In some implementations, the intra-AS routers 106 comprise a router, switch, bridge, hub, gateway, etc. In some implementations, those of ordinary skill in the art will appreciate from the present disclosure that the AS 102-15 includes an arbitrary number of border routers 104 and an arbitrary number of intra-AS routers 106.

In some implementations, at least some of the nodes within the AS 102-15, such as the border routers 104 or at least some of the intra-AS routers 106, are configured to maintain one or more traffic counters according to a predefined monitoring period (e.g., a sampling frequency such as 30 seconds, 60 seconds, 90 seconds, 5 minutes, 15 minutes, or the like). In some implementations, at least some of the nodes within the AS 102-15, such as the border routers 104 or at least some of the intra-AS routers 106, are configured to maintain traffic counters for associated interfaces according to the predefined monitoring period. In some implementations, a traffic counter characterizes the traffic that traverses the node or an interface thereof during the predefined monitoring period.

According to some implementations, each node must process each packet (e.g., Internet protocol (IP) packets) that traverses it to determine the number of bits associated with the packets to maintain traffic counters. In various implementations, routers and/or switches are enabled to maintain traffic counters, for example, by monitoring and tracking for various fields within packets such as the number of bits associated with it.

In some implementations, the nodes export one or more traffic counters to the network controller 110 at the end of the monitoring period. In some implementations, the network controller 110 sends requests to the nodes for traffic counters according to the monitoring period. In some implementations, traffic counters are maintained on an interface-by-interface basis. As one example, the number of interfaces in the AS 102-15 is approximately 10⁵ to 10⁶. Thus, in this example, the network controller 110 obtains approximately 10⁵ to 10⁶ traffic counters every monitoring period.

In some implementations, the traffic counter memory 125 (e.g., an associative array) stores traffic counters obtained from the nodes within the AS 102-15. According to some implementations, the traffic counter memory 125 stores traffic counters according to a predetermined number of monitoring periods (e.g., a specified monitoring window associated with 5 monitoring periods).

In some implementations, the network configuration database 115 stores internal information corresponding to the AS 102-15 (e.g., acquired via the simple network management protocol (SNMP) or another protocol) such as interface names, IP addresses used by the interfaces, routers names, and topology. In some implementations, the network configuration database 115 also stores external information corresponds to external AS's (e.g., acquired via BGP or another protocol) such as the topology of the external AS's connected to the AS 102-15 and IP addresses of at least some of the external AS's connected to the AS 102-15.

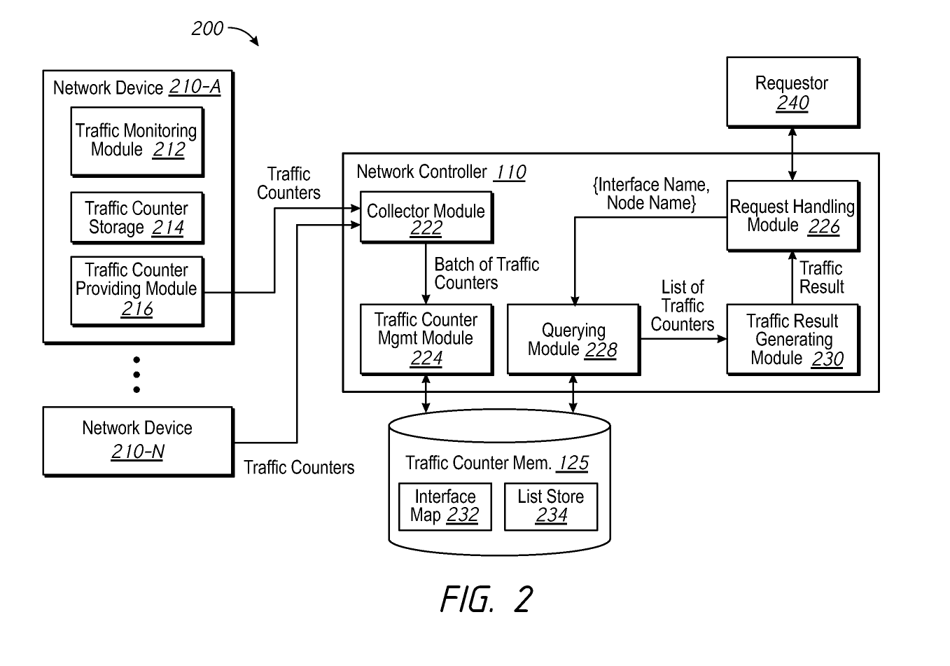

FIG. 2 is a block diagram of a data processing environment 200 in accordance with some implementations. The data processing environment 200 shown in FIG. 2 is similar to and adapted from the data network environment 100 shown in FIG. 1. Elements common to FIGS. 1 and 2 include common reference numbers, and only the differences between FIGS. 1 and 2 are described herein for the sake of brevity. To that end, the data processing environment 200 includes a plurality of network devices 210-A, . . . , 210-N and a network controller 110.

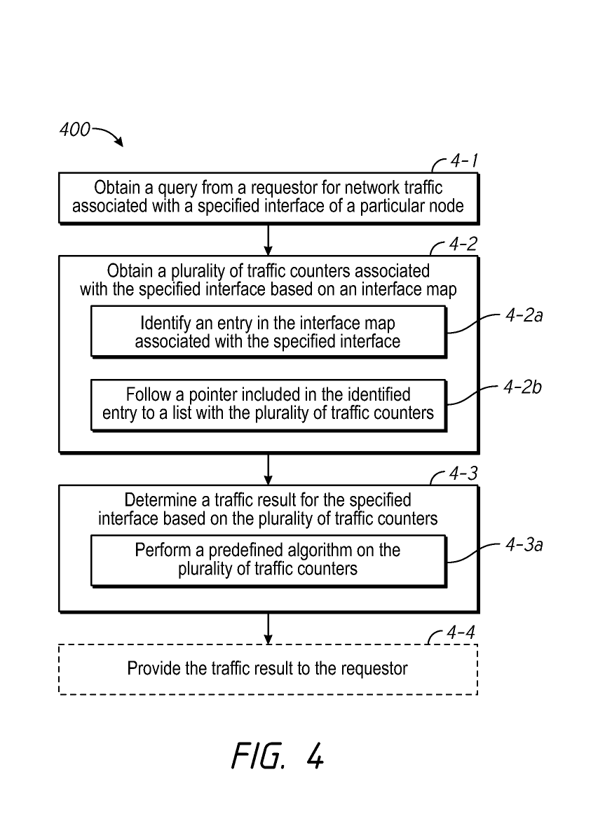

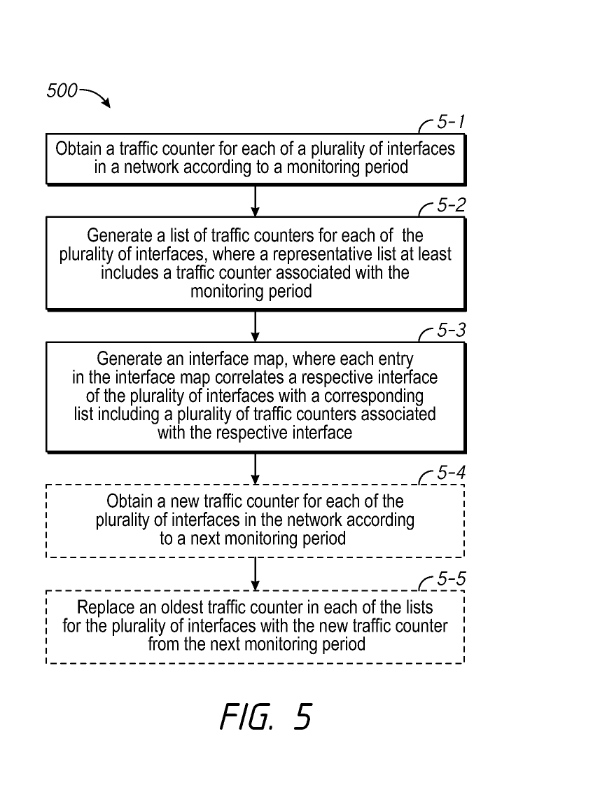

In some implementations, the network controller 110 includes a collector module 222, a traffic counter management module 224, a request handling module 226, a querying module 228, and a traffic result generating module 230, the function and operation of which are described in greater detail below with reference to FIGS. 4 and 5. In some implementations, representative network device 210-A includes a traffic monitoring module 212, a traffic counter storage 214, and a traffic counter providing module 216. For example, the network devices 210-A, . . . , 210-N correspond to border routers 104 in FIG. 1. In another example, the network devices 210-A, . . . , 210-N correspond to border routers 104 and at least some of the intra-AS routers 106 within the AS 102-15 in FIG. 1.

In some implementations, the traffic monitoring module 212 is configured to maintain a traffic counters for each interface associated with the network device 210-A for a predefined monitoring period (e.g., a sampling frequency such as 30 seconds, 60 seconds, 90 seconds, 5 minutes, 15 minutes, or the like). For example, a traffic counter indicates the aggregate amount of traffic that traverses an interface of the network device 210-A during the predetermined monitoring period. In another example, the traffic counter is a function of the amount of the traffic that traverses an interface of the network device 210-A during the predetermined monitoring period (e.g., a sample of traffic during the predetermined monitoring period). For example, the traffic monitoring module 212 inspects packets that traverse the network device 210-A and updates the traffic counters stored in the traffic counter storage 214. In some implementations, the traffic counter storage 214 is configured to store traffic counters for a plurality of monitoring periods (e.g., the last 10 monitoring periods) for each interface associated with the network device 210-A.

In some implementations, the traffic counter providing module 216 is configured to export the latest traffic counter(s) to the network controller 110 at the end of a monitoring period. For example, the nodes export traffic counters to the network controller 110 every X minutes (e.g., X=0.5, 1, 5, 10, 15, etc.). For example, the traffic counters are exported using the SNMP, the user datagram protocol (UDP), the stream control transmission protocol (SCTP), or as a file. In some implementations, traffic counter providing module 216 is configured to provide traffic counter(s) for a last monitoring period to the network controller 110 in response to a query from the network controller 110 for the traffic counter(s).

According to some implementations, the traffic counter memory 125 at least includes an interface map 232 and a list store 234. In some implementations, the interface map 232 includes an entry for each unique {interface, node} tuple. Furthermore, each entry in the interface map 232 includes a pointer to a traffic counter list in the list store 234 that is associated with a corresponding {interface, node} tuple. In some implementations, the list store 234 stores a plurality of traffic counter lists. For example, a respective one of the plurality of traffic counter lists includes a predetermined number of traffic counters for a corresponding {interface, node} tuple.

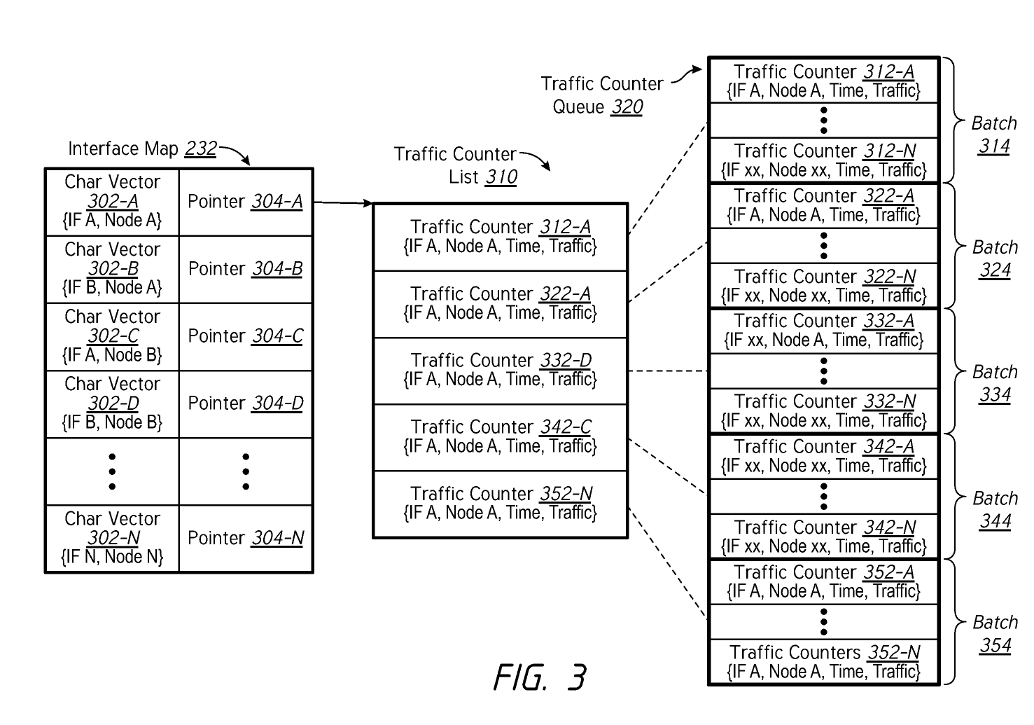

FIG. 3 is a block diagram of example data structures in accordance with some implementations. The data structures include an interface map 232, a traffic counter list 310, and a traffic counter queue 320.

In some implementations, with reference to FIG. 2, the interface map 232 is generated and maintained by network controller 110 or a component thereof (e.g., the traffic counter management module 224). In some implementations, with reference to FIG. 2, the interface map 232 is stored in the traffic counter memory 125. The process by which the interface map 232 is generated is described in detail with reference to block 5-3 of FIG. 5.

In some implementations, with reference to FIG. 2, the traffic counter list 310 for the tuple characterized by {interface A, node A} is generated and maintained by network controller 110 or a component thereof (e.g., the traffic counter management module 224). In some implementations, with reference to FIG. 2, the traffic counter list 310 is one of a plurality of traffic lists stored in the list store 234 of the traffic counter memory 125. The process by which the traffic counters list 310 is generated is described in detail with reference to block 5-2 of FIG. 5.

As shown in FIG. 3, the interface map 232 includes a plurality of entries, where each entry corresponds to a characterization vector 302 field and a pointer 304 field. For example, as shown in FIG. 3, each characterization vector 302 is associated with a unique tuple defined by {interface name, node name} such as {interface A, node A} for characterization vector 302-A. As such, in this example, each entry of the interface map 232 corresponds to a specified interface of a particular node in the network (e.g., the AS 102-15). In other words, the interface map 232 includes an entry for each interface in the network (e.g., the AS 102-15 in FIG. 1). In some implementations, those of ordinary skill in the art will appreciate from the present disclosure that the characterization vectors 302 in the interface map 232 are defined by a set of various other suitable characteristics in other embodiments (e.g., an n-tuple defined by {node name}, {node name, protocol (e.g., TCP, UDP, IPv4, IPv6, etc.)}, {interface name, node name, protocol}, {interface name, node name, type of traffic (e.g., unicast, multicast, etc.)}, or the like).

As shown in FIG. 3, the pointer 304-A points to a traffic counter list 310 or a location thereof. For example, as shown in FIG. 3, the traffic counter list 310 includes a predetermined number of traffic counters (e.g., 6) that correspond to the tuple defined by {interface A, node A}. In some implementations, the traffic counter list 310 includes at least a predetermined number of traffic counters set according to one or more accuracy criteria (e.g., a specified monitoring window associated with 6 monitoring periods). According to some implementations, each of the traffic counters in the traffic counter list 310 is characterized by an interface name, a node name, a time (e.g., a timestamp characterized by the time the traffic counter was produced or the time the traffic counter was provided to the network controller 110), and a traffic value.

According to some implementations, each of the traffic counters 312-A, 322-A, 332-D, 342-C, 352-N corresponds to traffic that traversed interface A of node A during distinct monitoring periods. In other words, each of the traffic counters in the traffic counter list 310 correspond to different batches of traffic counters that comprise a traffic counter queue 320, which could be structured as a single or double-ended queue. For example, traffic counter 312-A corresponds to a first batch 314 of traffic counters for a first monitoring period (e.g., the oldest monitoring period), traffic counter 322-A corresponds to a second batch 324 of traffic counters for a second monitoring period, traffic counter 332-D corresponds to a third batch 334 of traffic counters for a third monitoring period, traffic counter 342-C corresponds to a fourth batch 344 of traffic counters for a fourth monitoring period, and traffic counter 352-N corresponds to a fifth batch 354 of traffic counters for a fifth monitoring period (e.g., the most recent monitoring period).

In some implementations, the traffic counter queue 320 comprises a predetermined number of traffic counter batches (e.g., a specified monitoring window associated with 6 monitoring periods or sample times). Each of the traffic counter batches 314, 324, 334, 344, 354 includes a traffic counter for each interface in the network (e.g., the AS 102-15) during a distinct monitoring period. For example, with reference to FIG. 2, if a new batch of traffic counters is obtained, the network controller 110 or a component thereof (e.g., the traffic counter management module 224) removes the oldest batch of traffic counters (e.g., batch 314) from the traffic counter queue 320 and also removes traffic counters included in the oldest batch from traffic counter lists in the list store 234 (e.g., including removing traffic counter 312-A from the traffic counter list 310). Continuing with this example, the network controller 110 or a component thereof (e.g., the traffic counter management module 224) adds the new batch of traffic counters to the traffic counter queue 320 and adds each traffic counter to a corresponding traffic counter list in the list store 234.

FIG. 4 is a flowchart representation of a method 400 of responding to traffic queries in accordance with some implementations. In various implementations, the method 400 is performed by a network controller (e.g., the network controller 110 in FIGS. 1-2) or one or more components thereof. Briefly, the method 400 includes: obtaining a query from a requestor for network traffic associated with a specified interface of a particular node; obtaining a plurality of traffic counters associated with the specified interface based on an interface map that at least correlates the interface with a list including the plurality of traffic counters; determining a traffic result for the interface based on the plurality of traffic counters; and, optionally, providing the traffic result to the requestor.

To that end, as represented by block 4-1, the method 400 includes obtaining a query from a requestor for network traffic associated with a specified interface of a particular node. For example, with reference to FIG. 2, the network controller 110 or a component thereof (e.g., the request handling module 226) obtains a query from a requestor 240 for network traffic associated with an interface of a node (e.g., a router or a switch) in a network (e.g., the AS 102-15). Continuing with this example, in some implementations, the request handling module 226 provides the specified interface associated with the query or a tuple defined by {interface name, node name} to the querying module 228. In some implementations, with reference to FIG. 2, the requestor 240 is an operator of the monitored AS 102-15 in FIG. 1. In some implementations, with reference to FIG. 2, the requestor 240 is a traffic monitoring process associated with the network controller 110 or another device.

In some implementations, the query at least specifies an interface of a particular node. In some implementations, the query also includes a particular time window (e.g., traffic associated with the last 10 minutes) in addition to the specified interface. In some implementations, the query requests the sum of the traffic for a specified interface for all available traffic counters associated with the specified interface. In some implementations, the query further includes one or more filtering criteria (e.g., protocol, type of traffic, etc.) in addition to the specified interface. In some implementations, the query also requests the status of the specified interface (e.g., active or inactive).

As represented by block 4-2, the method 400 includes obtaining a plurality of traffic counters associated with the specified interface based on an interface map. In some implementations, the interface map includes an entry for each interface in the network, and each entry is characterized by a pointer to a list including a plurality of traffic counters for a corresponding interface and a characterization vector associated with the corresponding interface. For example, with reference to FIG. 2, the network controller 110 or a component thereof (e.g., the querying module 228) obtains a list including a plurality of traffic counters associated with the specified interface from the list store 234 based on the interface map 232. Continuing with this example, in some implementations, the querying module 228 provides the plurality of traffic counters associated with the specified interface to the traffic result generating module 230.

In some implementations, as represented by block 4-2a, the method 400 includes identifying an entry in the interface map associated with the specified interface. For example, with reference to FIG. 2, the network controller 110 or a component thereof (e.g., the querying module 228) identifies an entry in the interface map 232 that corresponds to the specified interface or the {interface name, node name} tuple.

In some implementations, as represented by block 4-2b, the method 400 includes following the pointer included in the identified entry to a list with the plurality of traffic counters. For example, with reference to FIG. 2, the network controller 110 or a component thereof (e.g., the querying module 228) follows the pointer included in the entry identified in block 4-2a to a list in the list store 234 with the plurality of traffic counters associated with the specified interface or the {interface name, node name} tuple.

In some implementations, the interface map is a hash map. As such, in some implementations, the network controller 110 or a component thereof (e.g., the querying module 228) obtains the plurality of traffic counters associated with the specified interface by: determining a hash value (e.g., a key) based on the {interface name, node name} tuple specified by the request; identifying an entry in the interface map 232 that corresponds to the hash value, where the entry correlates the {interface name, node name} tuple with a pointer to a list with the plurality of traffics counters in the list store 234 or a location thereof; and obtaining the plurality of traffic counters from the list by following the pointer to the list.

As represented by block 4-3, the method 400 includes determining a traffic result for the specified interface based on the plurality of traffic counters. For example, with reference to FIG. 2, the network controller 110 or a component thereof (e.g., the traffic result generating module 230) determines a traffic result based on the plurality of traffic counters obtained from the querying module 228. Continuing with this example, in some implementations, the traffic result generating module 230 provides the traffic result to the request handling module 226. In some implementations, the traffic result is a function of the network traffic handled by the specified interface over a predetermined time period (e.g., a specified monitoring window). For example, a traffic trend is computed based on a predefined algorithm for the plurality of traffic counters. In another example, the highest traffic counter value among the plurality of traffic counters is used as traffic result. In another example, the lowest traffic counter value among the plurality of traffic counters is used as traffic result. In yet another example, an average traffic measurement is computed from the plurality of traffic counters. In yet another example, a median traffic measurement is computed from the plurality of traffic counters.

In some implementations, as represented by block 4-3a, the method 400 includes determining the traffic result by performing a predefined algorithm on the plurality of traffic counters to obtain the traffic result. For example, with reference to FIG. 2, the network controller 110 or a component thereof (e.g., the traffic result generating module 230) computes a traffic result by computing the slope of a line plotted between the oldest and newest traffic counters in the plurality of traffic counters. In another example, with reference to FIG. 2, the network controller 110 or a component thereof (e.g., the traffic result generating module 230) performs a time-weighted moving average computation on the plurality of traffic counters. As one example, the plurality of traffic counters for the specified interface includes traffic measurements for a 6 consecutive (or discontinuous) 5 minute monitoring periods. As such, continuing with this example, the time-weighted moving average computation on the 6 traffic measurements smooths out any spikes and/or lulls in traffic. In some implementations, the predefined algorithm removes outlier traffic measurements that are greater than a first threshold traffic value and/or are less than a second threshold traffic value.

In some implementations, as represented by block 4-4, the method 400 includes providing the traffic result to the requestor. For example, with reference to FIG. 2, the network controller 110 or a component thereof (e.g., the request handling module 226) provides the traffic result to the requestor 240. For example, the network controller 110 sends the traffic result as a file, email, or the like to the operator of the network. In another example, the traffic result is stored such that the requestor can access it at any time via a GUI or analysis portal. In yet another example, the network controller 110 provides the traffic result value to another process for further analysis. In yet another example, the network controller 110 provides the traffic result value to the operator of the network when the traffic result exceeds a predefined threshold value. In some implementations, the network controller 110 provides, to the operator of the network, a predictive suggestion to scale-up the network (e.g., add line cards to particular nodes) or re-route traffic based on the traffic result for the specified interface.

FIG. 5 is a flowchart representation of a method 500 of generating and maintaining an interface map in accordance with some implementations. In various implementations, the method 500 is performed by a network controller (e.g., the network controller 110 in FIGS. 1-2) or one or more components thereof. Briefly, the method 500 includes: obtaining a traffic counter for each of a plurality of interfaces in a network according to a monitoring period; generating a list of traffic counters for each of the plurality of interfaces, where a representative list at least includes a traffic counter associated with the monitoring period; and generating an interface map, where each entry in the interface map correlates a respective interface of the plurality of interfaces with a corresponding list including a plurality of traffic counters associated with the respective interface.

To that end, as represented by block 5-1, the method 500 includes obtaining a traffic counter for each of a plurality of interfaces in a network according to a monitoring period. For example, with reference to FIG. 2, the network controller 110 or a component thereof (e.g., the collector module 222) obtains a traffic counter for each of the interfaces in the network (e.g., the AS 102-15) according to a monitoring period (e.g., a sampling frequency such as 30 seconds, 60 seconds, 90 seconds, 5 minutes, 15 minutes, or the like). Continuing with this example, with reference to FIG. 2, the collector module 222 provides the batch of traffic counters corresponding to the monitoring period to the traffic counter management module 224 for storage in the traffic counter memory 125. In some implementations, with reference to FIG. 2, the network devices 210 export traffic counters for associated interfaces to the network controller 110 at the end of the monitoring period. In some implementations, with reference to FIG. 2, the network controller 110 or a component thereof (e.g., the collector module 222) polls the network devices 210 (e.g., at the end of the predetermined monitoring period) to provide the latest traffic counter(s).

As represented by block 5-2, the method 500 includes generating a list of traffic counters for each of the plurality of interfaces, where a representative list at least includes a traffic counter associated with the monitoring period. For example, with reference to FIG. 2, the network controller 110 or a component thereof (e.g., the traffic counter management module 224) generates a list of traffic counters (each at least including one of the traffic counters from the monitoring period) for each of the interfaces in the network based on obtained traffic counters and maintains the lists in the list store 234.

As represented by block 5-3, the method 500 includes generating an interface map, where each entry in the interface map correlates a respective interface of the plurality of interfaces with a corresponding list including a plurality of traffic counters associated with the interface. For example, with reference to FIG. 2, the network controller 110 or a component thereof (e.g., the traffic counter management module 224) generates and maintains an interface map 232, which correlates interfaces in the network with the list of traffic counters in the list store 234. The interface map 232 is described in more detail with reference to FIG. 3.

In some implementations, as represented by block 5-4, the method 500 includes obtaining a new traffic counter for each of the plurality of interfaces according to a next monitoring period. For example, with reference to FIG. 2, the network controller 110 or a component thereof (e.g., the collector module 222) obtains a traffic counter for each of the interfaces in the network (e.g., the AS 102-15) according to the next monitoring period.

In some implementations, as represented by block 5-5, the method 500 includes replacing an oldest traffic counter in each of the lists for the plurality of interfaces with the new traffic counter from the next monitoring period. For example, with reference to FIG. 2, the network controller 110 or a component thereof (e.g., the traffic counter management module 224) updates the lists of traffic counters by removing the oldest traffic counters and adding the new traffic counters associated with the next monitoring period. For example, the network controller obtains a new traffic for each interface every 5 minutes. Furthermore, continuing with this example, the network controller maintains batches of traffic counters for a specified monitoring window (e.g., 30 minutes or 6 batches of traffic counters).

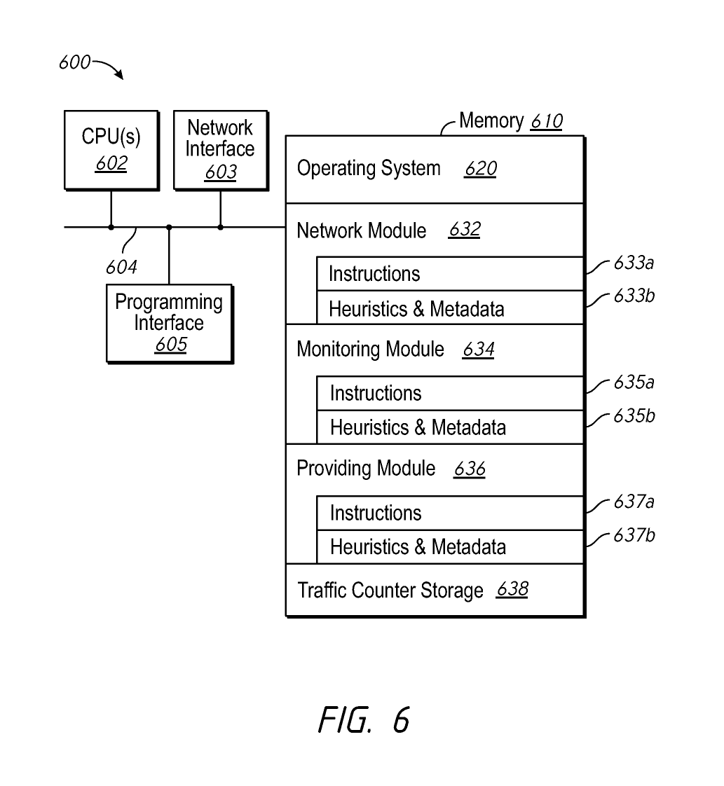

FIG. 6 is a block diagram of an example of a network device 600 configured in accordance with some implementations. For example, in some implementations, the endpoint device 600 is similar to and adapted from the network device 210-A in FIG. 2. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the endpoint device 600 includes one or more processing units (CPU's) 602, a network interface 603, a memory 610, a programming (I/O) interface 605, and one or more communication buses 604 for interconnecting these and various other components.

In some implementations, the one or more communication buses 604 include circuitry that interconnects and controls communications between system components. In some implementations, the memory 610 includes high-speed random access memory, such as DRAM, SRAM, DDR RAM, or other random access solid state memory devices. In some implementations, the memory 610 includes non-volatile memory, such as one or more magnetic disk storage devices, optical disk storage devices, flash memory devices, or other non-volatile solid state storage devices. The memory 610 optionally includes one or more storage devices remotely located from the CPU(s) 602. The memory 610 comprises a non-transitory computer readable storage medium. In some implementations, the memory 610 or the non-transitory computer readable storage medium of the memory 610 stores the following programs, modules and data structures, or a subset thereof including an optional operating system 620, a network module 632, an monitoring module 634, a providing module 636, and a traffic counter storage 638.

The operating system 620 includes procedures for handling various basic system services and for performing hardware dependent tasks.

In some implementations, the network module 632 is configured to provide networking capabilities such as packet routing and/or switching. To that end, in various implementations, the network module 632 includes instructions and/or logic 633a, and heuristics and metadata 633b.

In some implementations, the monitoring module 634 is configured to maintain traffic counters for interfaces of the network device 600 in the traffic counter storage 638, where a traffic counter characterizes an amount of traffic (e.g., packets) traversing an interface for a particular monitoring period. To that end, in various implementations, the obtaining module 634 includes instructions and/or logic 635a, and heuristics and metadata 635b. In some implementations, the monitoring module 634 is similar to and adapted from the monitoring module 212 in FIG. 2. In some implementations, the traffic counter storage 638 is configured to store one or more traffic counters for each interface associated with the network device 600.

In some implementations, the providing module 636 is configured to provide or periodically export traffic counters stored in the traffic counter storage 638 to a network controller (e.g., the network controller 110 in FIGS. 1-2). To that end, in various implementations, the exporting module 636 includes instructions and/or logic 637a, and heuristics and metadata 637b. In some implementations, the providing module 636 is similar to and adapted from the traffic counter providing module 216 in FIG. 2.

Although the network module 632, the monitoring module 634, and the providing module 636 are illustrated as residing on a single device (i.e., the network device 600), it should be understood that in other implementations, any combination of the network module 632, the monitoring module 634, and the providing module 636 reside in separate computing devices. For example, each of the network module 632, the monitoring module 634, and the providing module 636 reside on a separate device.

Moreover, FIG. 6 is intended more as functional description of the various features are present in a particular embodiment as opposed to a structural schematic of the implementations described herein. As recognized by those of ordinary skill in the art, items shown separately could be combined and some items could be separated. For example, some functional modules shown separately in FIG. 6 could be implemented in a single module and the various functions of single functional blocks could be implemented by one or more functional blocks in various implementations. The actual number of modules and the division of particular functions and how features are allocated among them will vary from one embodiment to another and, in some implementations, depends in part on the particular combination of hardware, software, and/or firmware chosen for a particular embodiment.

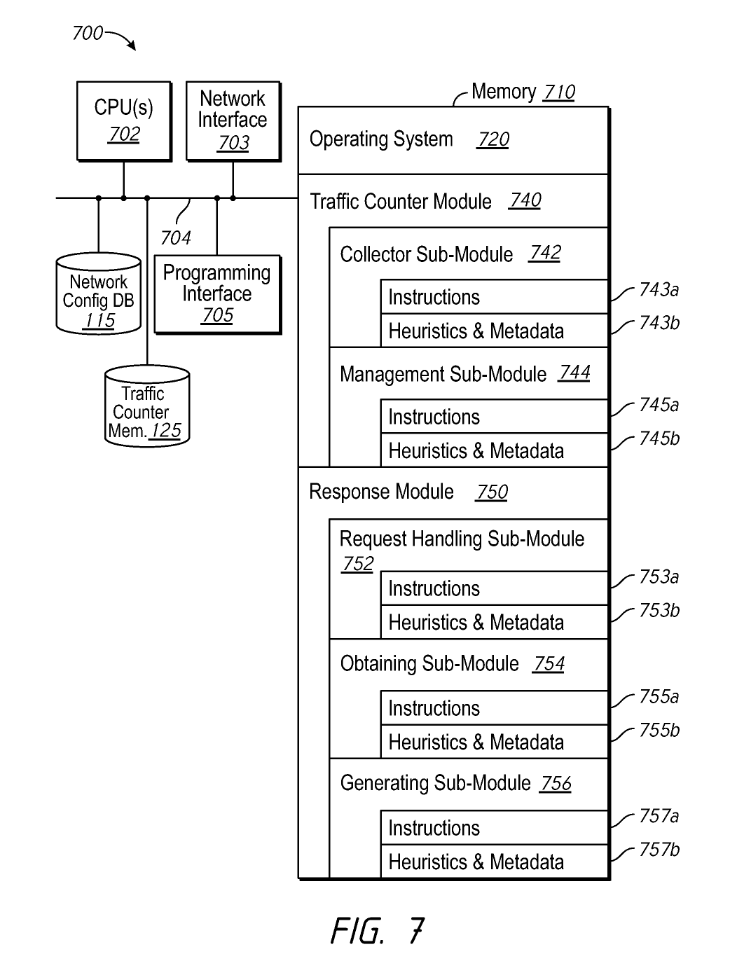

FIG. 7 is a block diagram of an example of a network controller 700 in accordance with some implementations. For example, in some implementations, the network controller 700 is similar to and adapted from the network controller 110 in FIGS. 1-2. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the network controller 700 includes one or more processing units (CPU's) 702, a network interface 703, a memory 710, a programming (I/O) interface 705, a network configuration database 115, a traffic counter memory 125, and one or more communication buses 704 for interconnecting these and various other components.

In some implementations, the one or more communication buses 704 include circuitry that interconnects and controls communications between system components. The network configuration database 115 stores internal information related to a network (e.g., the AS 102-15 in FIG. 1) that is monitored by the network controller 700 and external information related to other external networks that are connected to said network. The traffic counter memory 125 stores traffic counters obtained from the nodes within the network (e.g., the AS 102-15 in FIG. 1) that is monitored by the network controller 700.

The memory 710 includes high-speed random access memory, such as DRAM, SRAM, DDR RAM, or other random access solid state memory devices. In some implementations, the memory 710 includes non-volatile memory, such as one or more magnetic disk storage devices, optical disk storage devices, flash memory devices, or other non-volatile solid state storage devices. The memory 710 optionally includes one or more storage devices remotely located from the CPU(s) 702. The memory 710 comprises a non-transitory computer readable storage medium. In some implementations, the memory 710 or the non-transitory computer readable storage medium of the memory 710 stores the following programs, modules and data structures, or a subset thereof including an optional operating system 720, a traffic counter module 740, and a response module 750.

The operating system 720 includes procedures for handling various basic system services and for performing hardware dependent tasks.

In some implementations, the traffic counter module 740 is configured to collect and manage traffic counters obtained from nodes in the network. In some implementations, the traffic counter module 740 includes a collector sub-module 742 and a management sub-module 744.

In some implementations, the collector sub-module 742 is configured to collect traffic counters associated with traffic traversing particular interfaces from network devices within the network (e.g., the AS 102-15 in FIG. 1) that is monitored by the network controller 700. To that end, in various implementations, the collector sub-module 742 includes instructions and/or logic 743a, and heuristics and metadata 743b. In some implementations, the collector sub-module 742 is similar to and adapted from the collector module 222 (FIG. 2) which is described in further detail with reference to FIG. 5.

In some implementations, the management sub-module 744 is configured to manage the traffic counters collected by the collector sub-module 742 by generating an interface map (e.g., the interface map 232 in FIGS. 2-3) and maintaining a list of traffic counters for each interface in the network (e.g., the list store 234 in FIG. 2). To that end, in various implementations, the management sub-module 744 includes instructions and/or logic 745a, and heuristics and metadata 745b. In some implementations, the management sub-module 744 is similar to and adapted from the traffic counter management module 224 (FIG. 2) which is described in further detail with reference to FIG. 5.

In some implementations, the response module 750 is configured to responds to requests for network traffic associated with a specified interface in the network (e.g., the AS 102-15 in FIG. 1) that is monitored by the network controller 700. In some implementations, the response module 750 includes a requesting handling sub-module 752, an obtaining sub-module 754, and a generating sub-module 756.

In some implementations, the requesting handling sub-module 752 is configured to obtain a query from a requestor for network traffic associated with a specified interface and provide a traffic result generated by generating sub-module 756 to the requestor. To that end, in various implementations, the requesting handling sub-module 752 includes instructions and/or logic 753a, and heuristics and metadata 753b. In some implementations, the requesting handling sub-module 752 is similar to and adapted from the requesting handling module 226 in FIG. 2.

In some implementations, the obtaining sub-module 754 is configured to obtain a plurality of traffic counters associated with the specified interface based on an interface map (e.g., the interface map 232 in FIGS. 2-3) that correlates the specified interface with a list including the plurality of traffic counters. To that end, in various implementations, the obtaining sub-module 754 includes instructions and/or logic 755a, and heuristics and metadata 755b. In some implementations, the obtaining sub-module 754 is similar to and adapted from the querying module 228 in FIG. 2.

In some implementations, the generating sub-module 756 is configured to a traffic result based on the plurality of traffic counters obtained by the obtaining sub-module 754. To that end, in various implementations, the generating sub-module 756 includes instructions and/or logic 757a, and heuristics and metadata 757b. In some implementations, the generating sub-module 756 is similar to and adapted from the traffic result generating module 230 in FIG. 2.

Although the traffic counter module 740 and the response module 750 are illustrated as residing on a single device (i.e., the network controller 700), it should be understood that in other implementations, any combination of the traffic counter module 740 and the response module 750 reside in separate computing devices. For example, each of the traffic counter module 740 and the response module 750 reside on a separate device.

Moreover, FIG. 7 is intended more as functional description of the various features which be present in a particular embodiment as opposed to a structural schematic of the implementations described herein. As recognized by those of ordinary skill in the art, items shown separately could be combined and some items could be separated. For example, some functional modules shown separately in FIG. 7 could be implemented in a single module and the various functions of single functional blocks could be implemented by one or more functional blocks in various implementations. The actual number of modules and the division of particular functions and how features are allocated among them will vary from one embodiment to another and, in some implementations, may depend in part on the particular combination of hardware, software, and/or firmware chosen for a particular embodiment.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first sample could be termed a second sample, and, similarly, a second sample could be termed a first sample, which changing the meaning of the description, so long as all occurrences of the “first sample” are renamed consistently and all occurrences of the “second sample” are renamed consistently. The first sample and the second sample are both samples, but they are not the same sample.

The terminology used herein is for the purpose of describing particular embodiments only and is not intended to be limiting of the claims. As used in the description of the embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
obtaining a query for network traffic associated with an interface of a node in a network;
obtaining a plurality of traffic counters associated with the interface based on an interface map, wherein each of the traffic counters characterizes an amount of traffic traversing the interface for a particular monitoring period; and
determining a traffic result for the interface based on the plurality of traffic counters, wherein the traffic result is a function of the network traffic handled by the interface over a predetermined time period.

2. The method of claim 1, wherein the interface map includes an entry for each interface in the network, and wherein each entry is characterized by a pointer to a list including a plurality of traffic counters for a corresponding interface and a characterization vector associated with the corresponding interface.

3. The method of claim 2, wherein the characterization vector is a tuple characterized by a name of the corresponding interface and a name of a node associated with the corresponding interface.

4. The method of claim 1, wherein obtaining the plurality of traffic counters associated with the interface comprises:
identifying an entry in the interface map that is associated with the interface, wherein the entry correlates the interface with a pointer to the list; and
obtaining the plurality of traffic counters from the list by following the pointer to the list.

5. The method of claim 1, wherein the interface map is a hash map, and wherein obtaining the plurality of traffic counters associated with the interface comprises:
determining a hash value based on the interface specified by the request;
identifying an entry in the interface map based on the hash value, wherein the entry correlates the interface with a pointer to the list; and
obtaining the plurality of traffic counters from the list by following the pointer to the list.

6. The method of claim 1, wherein determining a traffic result for the interface based on the plurality of traffic counters in the list comprises:
performing a predefined algorithm on the plurality of traffic counters in the list to obtain the traffic result for the interface.

7. The method of claim 6, wherein the predefined algorithm is a time-weighted moving average computation on the plurality of traffic counters.

8. The method of claim 1, further comprising:
obtaining a new traffic counter for each interface in the network; and
replacing an oldest traffic counter in each of the lists for the interfaces in the network with the new traffic counter.

9. The method of claim 1, wherein the list includes at least a predetermined number of traffic counters set according to one or more accuracy criteria.

10. The method of claim 1, wherein the request is obtained from a requestor, the method further comprising:
providing the traffic result to the requestor.

11. A device comprising:
a query handling module configured to obtain a query for network traffic associated with an interface of a node in a network;
a traffic counter querying module configured to obtain a plurality of traffic counters associated with the interface based on an interface map, wherein each of the traffic counters characterizes an amount of traffic traversing the interface for a particular monitoring period; and
a traffic result generating module configured to determine a traffic result for the interface based on the plurality of traffic counters, wherein the traffic result is a function of the network traffic handled by the interface over a predetermined time period.

12. The device of claim 11, wherein the interface map includes an entry for each interface in the network, and wherein each entry is characterized by a pointer to a list including a plurality of traffic counters for a corresponding interface and a characterization vector associated with the corresponding interface.

13. The device of claim 12, wherein the characterization vector is a tuple characterized by a name of the corresponding interface and a name of a node associated with the corresponding interface.

14. The device of claim 11, wherein obtaining the plurality of traffic counters associated with the interface comprises:
identifying an entry in the interface map that is associated with the interface, wherein the entry correlates the interface with a pointer to the list; and
obtaining the plurality of traffic counters from the list by following the pointer to the list.

15. The device of claim 11, wherein the list includes at least a predetermined number of traffic counters set according to one or more accuracy criteria.

16. A device comprising:
means for obtaining a query for network traffic associated with an interface of a node in a network;
means for obtaining a plurality of traffic counters associated with the interface based on an interface map, wherein each of the traffic counters characterizes an amount of traffic traversing the interface for a particular monitoring period; and
means for determining a traffic result for the interface based on the plurality of traffic counters, wherein the traffic result is a function of the network traffic handled by the interface over a predetermined time period.

17. The device of claim 16, wherein the interface map includes an entry for each interface in the network, and wherein each entry is characterized by a pointer to a list including a plurality of traffic counters for a corresponding interface and a characterization vector associated with the corresponding interface.

18. The device of claim 17, wherein the characterization vector is a tuple characterized by a name of the corresponding interface and a name of a node associated with the corresponding interface.

19. The device of claim 16, wherein the means for obtaining the plurality of traffic counters associated with the interface comprises:
means for identifying an entry in the interface map that is associated with the interface, wherein the entry correlates the interface with a pointer to the list; and
means for obtaining the plurality of traffic counters from the list by following the pointer to the list.

20. The device of claim 16, wherein the list includes at least a predetermined number of traffic counters set according to one or more accuracy criteria.
